(19) United States
(12) Patent Application Publication
(10) Pub. No.: US 2017/0219232 A1
(43) Pub. Date: Aug. 3, 2017

(54) IMPROVED COMMAND FOR THERMAL DEVICE

(71) Applicant: MULLER & CIE, Paris (FR)

(72) Inventors: Philippe Lemaire, Paris (FR); Jean-Louis Morard, Paris (FR); Francois Pourrat, Paris (FR)

(21) Appl. No.: 15/304,088

(22) PCT Filed: Apr. 9, 2015
(86) PCT No.: PCT/FR2015/050938

§ 371 Date: Oct. 14, 2016

(30) Foreign Application Priority Data
Apr. 17, 2014 (FR) 14 53518

(51) Int. Cl. F24F 11/00; G05B 19/042; G05D 23/19

(52) U.S. Cl. CPC F24F 11/006; F24F 11/0086; G05D 23/1917; G05D 23/1934; G05B 19/0426; F24F 2011/0067; F24F 2011/0073; F24F 2011/0091; G05B 2219/2614

(57) ABSTRACT

The disclosure relates to the command of a thermal device and more specifically a control box for such a device, comprising a communication interface with an energy and driving manager for receiving centralized operating settings from the manager defining, for this device, a centralized operating mode in which the device applies the aforementioned settings. The box furthermore comprises an interface for entry of local operating preferences, where the communication interface is arranged for communicating the operating preferences to the manager in order to change the centralized operating settings associated with the device based on the operating preferences.

The present invention relates to the domain of the command of thermal devices such as a heating/ventilation/air conditioning devices with energy recovery/hot water production, in particular in a facility (domestic or professional).

The devices are typically connected to an energy and driving manager which sends each device operating settings according to a general preference of the user (for example a target temperature throughout the residence). Just the same, this general target temperature does not necessarily correspond to a temperature suited to one given room, for example, considering in particular the means of insulation thereof.

The present invention aims to improve the situation.

For this purpose, it proposes a control box for a thermal device, comprising a communication interface with an energy and driving manager for receiving centralized operating settings from the manager defining, for the device in question, a centralized operating mode in which the device applies the settings.

In particular, the box furthermore comprises an interface for entry of local operating preferences, where the communication interface is arranged for communicating the operating preferences to the energy and driving manager in order to change the centralized operating settings associated with the thermal device based on the operating preferences.

The present invention then allows defining local preferences specific to the user, for example when the user is in a room in which the thermal device operates, and in particular defining a reference temperature specific to the operation of the device in the room for example, where this reference temperature is communicated to the energy and driving manager for storage there.

In that way, in an embodiment, the aforementioned preferences comprise at least the definition of a reference operating temperature of the device, where this reference temperature is then sent to the energy and driving manager in order to modify the central operating settings based on this reference temperature.

The present invention also makes it possible to make the device run according to a local mode without intervention of the aforementioned manager.

In that way, in an embodiment, the entry interface comprises a command member to switch the device from the centralized operating mode to a local operating mode, in which the device applies local operating settings, where these local operating settings can be chosen with the entry interface.

In particular, the local operating mode and the centralized operating mode can comprise “operating sub-modes” (later called “comfort mode”, “savings mode” and “prevent-freezing mode”) which can of course differ in temperature but could also differ in degree of humidity, airspeed, noise level or other setting parameter possible with the thermal device.

In that way in a specific implementation, the command box is arranged to propose via a menu the selection of a local operating mode from among several local operating sub-modes corresponding to homologous sub-modes of centralized operation.

In particular, through this selection, the user can be offered a choice in the area of operating preferences during initialization of the local operating mode.

In a specific implementation, the operating sub-modes are defined at least by the respective reference temperatures.

In particular it is possible to associate different reference temperatures with different operating sub-modes (in local or centralized mode) such as for example a relatively high temperature (around 19° C.) in “comfort mode”, a lower temperature (for example 3.5° C. less) in “savings mode” and a reference temperature of 7°, for example, in prevent-freezing mode.

In an embodiment, the command box comprises a selection member for an end of local operating mode condition comprising a time-delay length or a change of the centralized operating settings sent to the device, where the box is arranged for commanding the switching of the device from the local operating mode to the centralized operating mode in response to confirmation of the condition in question.

In that way, the user can preprogram the conditions for switching the device from a local operating mode to a centralized operating mode. It can for example involve switching the operation to centralized mode after a time delay or after a time of day has been reached (for example midnight). It is also possible that a change of settings in the energy and driving manager, for example by following a programmed schedule of load shedding (or “blanking” for not consuming energy beyond a limit), also causes a switchover from local mode to centralized mode, with the possible change of sub-mode, for example from “comfort mode” to “savings mode”.

Thus, the energy consumption of a thermal device can be limited by such an implementation.

Also, in a specific embodiment, the box is configured for switching the device from the local operating mode to an operating mode driven by said manager upon receiving a load shedding or tariff reduction setting.

In an embodiment, the command box comprises a member for a command to reinitialize the centralized operating settings and local operating settings to default values.

Thus, this implementation allows the user to simply correct changes made to the device operating preferences, for example in case of repeated unintended operations, in order to return to default operating values.

In a specific implementation, the box is arranged for triggering the switching of the device from local operating mode to centralized operating mode upon detecting that the user is not near the device for a preset time.

In a general way, this implementation allows the user to remotely recover control of the device when it is not in local operating mode although the user does not have access to the device. In a specific example, such an implementation in particular allows passing from local “comfort” operating mode to the centralized “savings” operating mode. In that way, for example, when the device is in comfort mode but no user is detected around the device for a preset time, the manager can remotely switch the device to savings mode (or, according to the prerecorded preferences, prevent-freezing mode).

Alternatively, embodiments are conceivable in which the box is arranged for triggering switching the device from “comfort” mode in centralized operation to “savings” mode in centralized operation, in case of detecting absence. Again alternatively, it is possible to drive a “comfort” operating mode upon detection of several occasions of presence of a user near the device, which serves to improve the ergonomics of use of the device.

Once the command box from the invention engages with the energy and driving manager, the invention also targets a system comprising a command box such as defined above and in particular an energy and driving manager able to:
Store and send centralized operating settings to said command box; and
Receive operating preferences from the command box and change the centralized operating settings based on operating preferences.

Additionally, the invention targets a command process for a thermal device (typically executed on the command box in the meaning of the invention), wherein:
Centralized operating settings are received from an energy and driving manager by means of a command box arranged on said device where the settings define a centralized operating mode of the device in which the device applies said settings;
Operating preferences are entered and said operating preferences are communicated to said manager via the command box; and
The centralized operating settings associated with said device are changed depending on operating preferences.

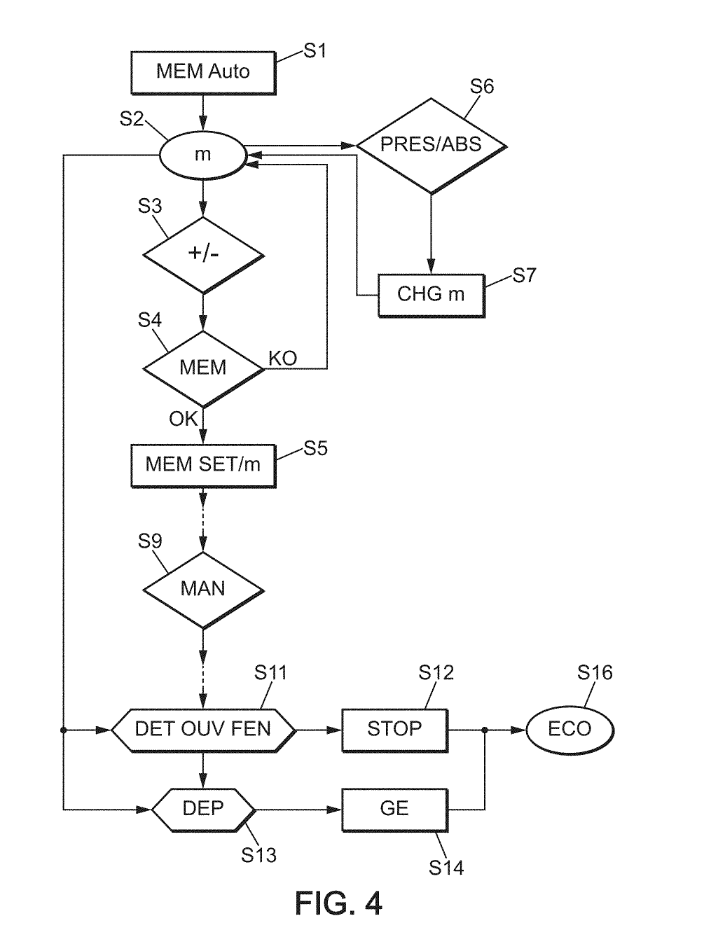

Finally, the invention targets a computer program (and of course the memory in which these instructions are stored), comprising instructions for implementing the aforementioned process, when this program is executed by a processor. FIG. 4 shows a possible flowchart for such a program.

Other features and advantages of the invention will appear on examining the following detailed description and the attached drawings in which:

FIG. 1 shows a sample installation in an application context of the invention;

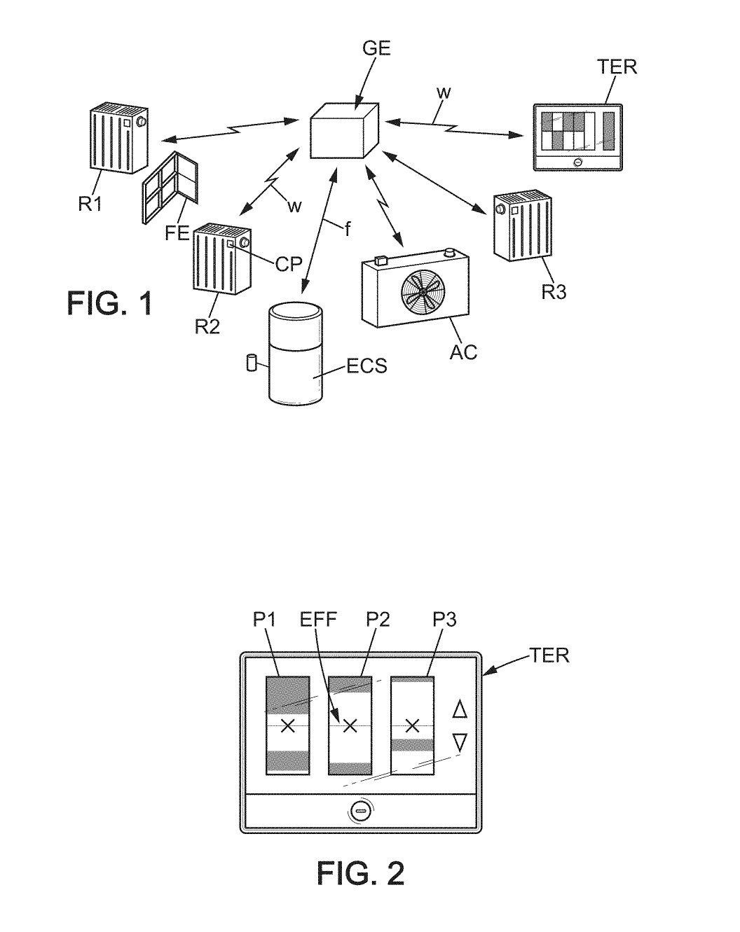

FIG. 2 shows a sample control screen for the general command of an installation according to FIG. 1;

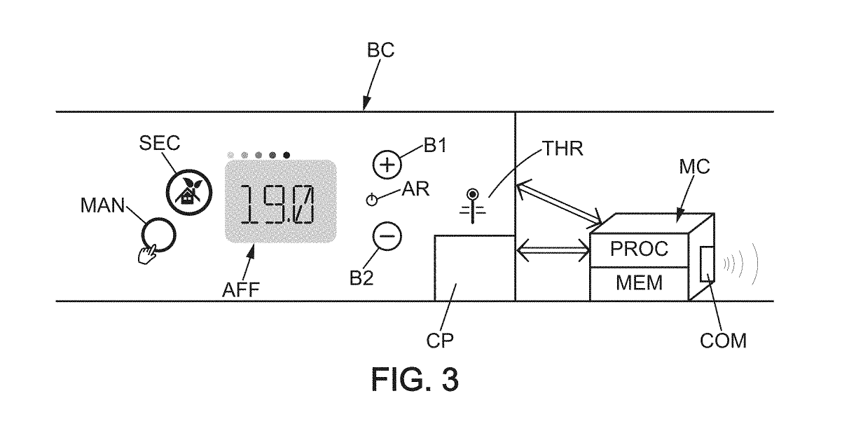

FIG. 3 shows a sample entry interface on a thermal device in an embodiment in the meaning of the invention;

FIG. 4 shows steps from a process example in the meaning of the invention.

Referring to FIG. 1, an installation for the implementation of the process in the meaning of the invention is shown. The installation comprises a plurality of thermal devices. It can involve heating, ventilation or air conditioning units with heat recovery or even sanitary hot water production. “Thermal device” is understood generally as any heat exchanger equipment capable of raising or lowering the temperature of a fluid.

In that way, as an example on FIG. 1, the heating radiators R1 and R2 are for example placed in one room comprising a window FE. Another radiator R3 is placed in another room, for example. The installation can additionally comprise an air conditioner AC, a hot water tank ECS, etc.

These devices are connected to an energy and driving manager, GE, for:
Receiving operating settings according to a succession of modes, preprogrammed in the energy and driving manager GE;
Passing information captured by the devices or entered by a user back to the energy and driving manager GE.

The connections between the devices and the energy and driving manager GE can be by radiofrequency (arrow w with a zigzag line) or wired (arrow f with a straight line).

The user of the installation can then enter a chosen succession of operating modes for the devices in their installation (for example through the interface of a terminal TER connected to the energy and driving manager GE for better ergonomics as shown in FIG. 2).

For example, the user can enter a daily desired temperature in each room of their space over one day. For example, the user can program:
in a bathroom, a high temperature (for example 22°) in early morning (top of column P3 in FIG. 2), and in the beginning of the evening (bottom of column P3);
in a bedroom, a comfort temperature (for example 19°) early in the night (bottom of column P2) until early morning (top of column P2);
in a dining room (column P1), a comfort temperature (19°) in the morning (corresponding for example to the presence of a family before going to a school and/or professional location) and in the beginning of the evening (at the return of the first family member, for example).

Outside these hourly ranges, the temperature can be lower (for example 3.5° below the aforementioned comfort temperature) as an energy savings measure. Hereafter this operating mode is called “savings mode”. Of course, during a prolonged absence, the temperature can be even lower (7° C. in “prevent-freezing” mode, for example).

Additionally, the user can program their preferences daily or weekly over a full week (with the possibility of different general preferences for the weekend days). Over a still longer timescale, the user can enter on their terminal information about specific events needing to occur on preset dates (for example a period of prolonged absence, or even a period called “blanking” (reference BLNK on FIG. 2) during which the user agrees with their energy supplier to limit their consumption to a fixed quantity).

The energy and driving manager GE then stores a succession of programmed operating modes for the devices, corresponding to the respective time ranges.

Once these parameters are entered, the energy and driving manager GE transmits, to the devices, the settings for operating modes corresponding to the programming by the user. The user can then read on their terminal TER the reference comfort level for each room (e.g. temperatures and possibly humidity, airspeed, noise level) and then adjust this comfort level according to, for example, their activity, clothing and also periods of occupancy and vacancy.

In return, the energy and driving manager GE can also receive information on specific events from the devices.

These specific events can correspond to entries made by a user on a command box of a device and/or detections by sensors (for example, a presence sensor CP on a device).

Such a command box BC is shown in FIG. 3.

The command box BC comprises, in the example shown, buttons to:
Run/stop the device, AR;
Raise B1 and lower B2, the operating temperature, for example, of the heating radiator;
Command SEC for automatic operation managed by the energy and driving manager GE (this command button can serve other functions described later);
Command MAN, for operation directly managed by a user of the device, with which the user can in that way take direct control of the operation of the device and in particular bypass an automatic operation driven by the energy and driving manager GE.

Of course the command box can additionally comprise a display screen AFF, in particular for a temperature setting given to the device. The device itself can furthermore comprises a thermostat THR, in order to measure a current temperature and possibly to reach a setting temperature, and also a presence sensor CP. The command box BC and the sensors (especially CP and THR) are connected to a command module MC of the device. This module MC comprises a processor PROC and working memory MEM for retrieving, interpreting and possibly storing data coming from the box BC and the sensors CP and THR. The memory MEM can additionally be programmed in order to allow standalone operation of the device independent of the energy and driving manager GE after pressing on the MAN button. The module MC can furthermore comprise an interface for communication (wireless or wired) with the energy and driving manager GE in particular to send information coming from the device.

One kind of information which can come from the relevant device, within the meaning of the invention, is a comfort temperature set personally by the user. In a sample implementation, the user can set the operating temperature of the device using buttons B1 and B2. If the user next wishes to store this setting by associating it with an operating mode (for example the “comfort” mode), the user makes a long press on the SEC button (for three seconds, for example). The temperature entered in that way is then stored in the device (in the memory MEM in the example shown) and also sent to the energy and driving manager GE to be stored there. This temperature becomes the reference temperature for the comfort mode and will then correspond, for subsequent settings, to the temperature to be associated with this mode for this device. It will additionally serve as reference for setting the temperature remotely for example from the terminal TER and via the energy and driving manager GE.

This reference temperature is set by the user, for example, with the door of the room closed (and the windows as well of course). It then is a matter of the temperature actually desired from the device by the user under actual conditions of use of the device in the room in which it is located. Thus, the present invention takes advantage of the fact that a user, in situ, is able to optimize the agreeable temperature for a given mode and in a given room.

Thus, the command module MC of the device is appropriate for an operation according to a mode selected directly by the user of the device, locally, when the user directly takes control of the device by pressing on the MAN button from FIG. 3. The operation of the device is then independent of the energy and driving manager GE except under conditions presented later with reference to FIG. 4.

Generally, just pressing on the ECO button allows the device to operate according to the programmed succession of operating modes of the device (for example in savings mode during the day and in comfort mode in the evening during the week). This programming was stored in the energy and driving manager GE (and could be entered by the user via their terminal).

On the other hand, pressing on the MAN button bypasses the operation according to the program to the succession of modes. For example, so if the current hourly range corresponds to a preprogrammed user absence and therefore a savings mode, a user who is actually present can switch to comfort mode by pressing on the MAN button. By pressing again on the MAN button, the user can choose a particular mode, for example prevent-freezing mode. This implementation is useful for sustainably taking control of the device and without subsequent involvement of the energy and driving manager GE. For example, pressing on the MAN button gives access to a mode selection menu (e.g. comfort, savings, prevent-freezing). In an advantageous implementation, the menu first proposes an operating mode other than the current mode (for example savings mode in case the current mode is comfort).

An example of a succession of steps in a process in the meaning of the invention is now described with reference to FIG. 4. At the outcome of the Step S1, the general preferences of the user have been entered (for example via their terminal TER) and stored in the energy and driving manager (GE). In that way, a given device can operate by receiving from the energy and driving manager GE the settings for a desired offset compared to the reference comfort temperature or according to a desired temperature setting or preprogrammed operating mode (e.g. comfort mode, savings mode or prevent-freezing mode) from the energy and driving manager GE, in step S2. At step S3, the user of the device adjusts the temperature that they want in a room from the command module COM of the device. Once the adjustment is done, if the user wishes to store this temperature, then in step S4 the user does a long press (about three seconds) on the ECO button of the device. This temperature then becomes their reference comfort temperature. This information is sent to the energy and driving manager GE which stores it and displays it for example on the terminal to serve as reference comfort level indicator. Otherwise (KO arrow leaving step S4) during the following operation of the device according to the current mode, the device will aim for a temperature corresponding to that stored before adjustment or automatically defined by the energy and driving manager GE following step S2. Once the user has done the long press (three seconds) on the ECO button (okay arrow leaving step S4), the new temperature value is stored in the device in step S5.

Other specific events can be communicated to the energy and driving manager GE. For example, an even longer press (eight seconds for example) by the user on the same ECO button directly on the device restores the comfort, energy savings mode and prevent-freezing temperatures there were pre-calibrated at the end of production of the device (for example, respectively 19°, 15.5° and 7° C.).

Additionally, a radiator for example can be equipped with a presence sensor CP which, as applicable, registers a user presence or absence in a room. Then referring to FIG. 4, if the device is operating according to a comfort mode manually requested by the user (press on the MAN button), a detection of a sustained absence in step S6 (for example after a time delay of several tens of minutes) can cause the energy and driving manager GE to take control. At step S7, this manager imposes a previously programmed mode (for example a savings mode, or a prevent-freezing mode if the detected absence is longer than a second preset time delay threshold).

Additionally, a window opening in a room can be detected, for example by a radiator thermostat, in the form of an abrupt temperature drop in this room. In this case, in an implementation example, stopping operation of the device can be called for. After a delay, the device can connect to the energy and driving manager GE to receive a pre-programmed operating mode setting and again operate according to this preprogrammed mode.

In that way, whether the user had selected the mode that it wanted using the MAN button or whether the operation of the device was driven by the energy and driving manager GE in preprogrammed mode (where the user had previously pressed on the SEC button), in case of window opening detection in step S11, the device stops operating in step S12, in an implementation example. After a time delay for example, the device can next operate according to a mode preprogrammed in the energy and driving manager GE in step S16.

Additionally, even after having received a message about direct control of a device by a user in step S9, if the energy and driving manager GE were previously programmed to follow an energy consumption limitation setting (for example a blanking) in step S13, the direct control of the device is canceled in step S14 and the operating bypass is ended according to the preferred mode of the user of the device. The energy and driving manager GE again drives the device in step S14 by having the device operate according to a savings mode in step S16, or by stopping the device, or else according to the programming initially called for by the user in response to the blanking conditions.

Additionally, after a time delay (for example on a fixed schedule, for example at midnight), the device can in an implementation example switch from an operating mode chosen by manual control (manual mode by pressing on the MAN button) to a predetermined mode driven by the energy and driving manager GE.

Of course, the present invention is not limited to the embodiments described above as examples; it extends to other variants.

In that way for example, the presentation of the entry interface shown as an example in FIG. 3 can be changed, although the ergonomics of this interface makes use very easy. For example, it is possible to provide a single ECO/MAN command button which opens a menu with which to select the pre-recorded succession of modes or operation according to a mode immediately sought by the user.

1. A command box for a thermal device, wherein the command box comprises:
a communication interface with an energy and driving manager for receiving centralized operating settings from the manager defining, for said device, a centralized operating mode in which the device applies said settings;
wherein the command box comprises an interface for entry of local operating preferences, where the communication interface is arranged for communicating said operating preferences to said manager in order to change the centralized operating settings associated with said device based on the operating preferences.

2. The command box according to claim 1, wherein said preferences comprise at least the definition of a reference operating temperature of the device and said reference temperature is sent to the manager in order to modify the central operating settings based on said reference temperature.

3. The command box according to claim 1, wherein the interface comprises a command member to switch the device from the centralized operating mode to a local operating mode, in which the device applies local operating settings, where said local operating settings can be chosen with the entry interface.

4. The command box according to claim 3, wherein the command box is arranged to propose via a menu the selection of a local operating mode from among several local operating sub-modes corresponding to homologous sub-modes of centralized operation.

5. The command box according to claim 4, wherein the operating sub-modes are defined at least by the respective reference temperatures,
wherein said preferences comprise at least the definition of a reference operating temperature of the device and said reference temperature is sent to the manager in order to modify the central operating settings based on said reference temperature.

6. The command box according to claim 3, wherein the command box comprises a selection member for an end of local operating mode condition comprising a time-delay length or a change of the centralized operating settings sent to the device, where the box is arranged for commanding the switching of the device from the local operating mode to the centralized operating mode in response to confirmation of said condition.

7. The command box according to claim 1, wherein the command box comprises a member for a command to reinitialize the centralized operating settings and local operating settings to default values.

8. The command box according to claim 1, wherein the box is arranged for triggering the switching of the device from local operating mode to centralized operating mode upon detecting that the user is not near the device for a preset time.

9. The command box according to claim 1, wherein the command box is configured for switching the device from the local operating mode to an operating mode driven by said manager upon receiving a load shedding or tariff reduction setting.

10. A system comprising a control box according to claim 1 and an energy and driving manager configured to:
store and send centralized operating settings to said command box;
receive operating preferences from the command box and change the centralized operating settings based on operating preferences.

11. A command process for a thermal device, wherein
centralized operating settings are received from an energy and driving manager by means of a command box arranged on said device where the settings define a centralized operating mode of the device in which the device applies said settings;
operating preferences are entered and said operating preferences are communicated to said manager via the command box; and
the centralized operating settings associated with said device are changed depending on operating preferences.

12. A non-transitory computer readable storage medium, with a program stored thereon, wherein the program comprises instructions for implementing the process according to claim 11 when this program is executed by a processor.
